(19) United States
(12) Patent Application Publication
(10) Pub. No.: US 2012/0234567 A1
(43) Pub. Date: Sep. 20, 2012

(54) ROCK DRILL OIL

(75) Inventors: MARK OKAZAKI, SAN RAMON, CA (US); ALLEN HEE, SAN RAMON, CA (US)

(73) Assignee: CHEVRON U.S.A. INC., San Ramon, CA (US)

(21) Appl. No.: 13/481,216

(22) Filed: May 25, 2012

Related U.S. Application Data
(62) Division of application No. 13/016,880, filed on Jan. 28, 2011.

(51) Int. Cl. C10M 129/68; E21B 3/00; B25D 9/00

(52) U.S. Cl. 173/114; 508/533; 173/218

(57) ABSTRACT

Provided is a lubricating oil composition suitable for use in rotary pneumatic and reciprocating tools, comprising a Fischer-Tropsch base oil, a friction modifier based on synthetic ester and a sulfurized extreme pressure agent. The present lubricating oil composition has superior wear, friction and extreme pressure characteristics.

### RELATED APPLICATIONS

The present application is a divisional of U.S. patent application Ser. No. 13/016880, filed Jan. 28, 2011, the contents of which are hereby incorporated by reference in their entirety.

### TECHNICAL FIELD

Provided is a rock drill fluid comprised of a Fischer-Tropsch based oil (FTBO) and an additive package. More particularly, the Fischer-Tropsch base oil is blended with an additive package comprising a friction modifier based on synthetic esters and a sulfurized extreme pressure agent.

### BACKGROUND

One of the key functions of any metalworking or rock drill fluid is to protect tools, parts or machine equipment from wear. These fluids add value to an operation in several ways, including the extension of equipment life, increased machining accuracy and the avoidance of unnecessary shutdowns. A common strategy for formulating a lubricant with good wear, friction and extreme pressure properties is to use additives that further modify friction between moving parts and/or protect metal surfaces. A common test used to benchmark the wear, friction and extreme pressure properties of a lubricant is the Falex EP test (ASTM 3233A).

Often a non-detergent motor oil or a hydraulic fluid is used to lubricate pneumatic tools. However, this type of oil is inadequate for the sophisticated and very-expensive tools of today. The demands of the constant pounding or hard work of a rotary tool requires a lubricant that can hold up much better than a hydraulic oil. The need for a suitable lubricating oil which exhibits the needed wear, friction and extreme pressure properties required by rotary pneumatic and reciprocating tools continues to exist.

### SUMMARY

Provided is a lubricating oil composition suitable for use in rotary pneumatic and reciprocating tools, comprising a Fischer-Tropsch base oil, a friction modifier based on synthetic esters and a sulfurized extreme pressure agent. The Viscosity Index (VI) of the Fischer-Tropsch base oil used in the composition is generally at least 120. The present lubricating oil composition has superior wear, friction and extreme pressure characteristics.

Among other factors, the present lubricating oil is predicated on the discovery that a Fischer-Tropsch base oil, when combined with a friction modifier additive based on synthetic ester, and a sulfurized extreme pressure agent, provides one with a lubricating oil of exceptional wear, friction and extreme pressure properties as compared to more conventional formulations. These properties are particularly seen when measured by the Falex Pin and Vee Block Machine. The present lubricating oil composition can therefore be readily used in rotary pneumatic and reciprocating tools, such as a rock drill or a jack hammer

### DETAILED DESCRIPTION

The term “comprising” mean including the elements or steps that are identified following that term, but any such elements or steps are not exhaustive, and an embodiment can include other elements or steps.

The present lubricating oil composition is based on a Fischer-Tropsch derived base oil. “Fischer-Tropsch derived” means that the product, fraction, or feed originates from or is produced at some stage by a Fischer-Tropsch process. As used herein, “Fischer-Tropsch base oil” may be used interchangeably with “FT base oil,” “FTBO,” “GTL base oil” (GTL: gas-to-liquid), or “Fischer-Tropsch derived base oil.” The feedstock for the Fischer-Tropsch process may come from a wide variety of hydrocarbonaceous sources, including natural gas, coal, shale oil, petroleum, municipal waste, derivatives and combinations thereof. The Fischer-Tropsch base oil used can be any suitable Fischer-Tropsch base oil.

For example, in a number of patent publications and applications, i.e., US2006/0289337, US2006/0201851, US2006/0016721, US2006/0016724, US2006/0076267, US2006/020185, US2006/013210, US2005/0241990, US2005/0077208, US2005/0139513, US2005/0139514, US2005/0133409, US2005/0133407, US2005/0261147, US2005/0261146, US2005/0261145, US2004/0159582, U.S. Pat. No. 7,018,525, U.S. Pat. No. 7,083,713, U.S. application Ser. Nos. 11/400,570, 11/535,165 and 11/613,936, which are incorporated herein by reference, a Fischer Tropsch base oil is produced from a process in which the feed is a waxy feed recovered from a Fischer-Tropsch synthesis. The process comprises a complete or partial hydroisomerization dewaxing step, using a dual-functional catalyst or a catalyst that can isomerize paraffins selectively. Hydroisomerization dewaxing is achieved by contacting the waxy feed with a hydroisomerization catalyst in an isomerization zone under hydroisomerizing conditions.

Fischer-Tropsch synthesis products can be obtained by well-known processes such as, for example, the commercial SASOL® Slurry Phase Fischer-Tropsch technology, the commercial SHELL® Middle Distillate Synthesis (SMDS) Process, or by the non-commercial EXXON® Advanced Gas Conversion (AGC-21) process. Details of these processes and others are described in, for example, EP-A-776959, EP-A-668342; U.S. Pat. Nos. 4,943,672, 5,059,299, 5,733,839, and RE39073; and US Published Application No. 2005/0227866, WO-A-9934917, WO-A-9920720 and WO-A-05107935. The Fischer-Tropsch synthesis product usually comprises hydrocarbons having 1 to 100, or even more than 100 carbon atoms, and typically includes paraffins, olefins and oxygenated products. Fischer Tropsch is a viable process to generate clean alternative hydrocarbon products.

In one embodiment, the Fischer-Tropsch base oil used in the present lubricating oil composition is of high viscosity index (VI). Generally, the viscosity index is at least 120, and in another embodiment, at least 150. In one embodiment, the Fischer-Tropsch base oil has a VI greater than an amount determined by the equation: VI=28×Ln(Kinematic Viscosity at 100° C.)+95. The Fischer-Tropsch base oil can be used alone or can be blended with another Fischer-Tropsch base oil. Minor amounts, e.g., less than 50 wt %, of other conventional base oils, such as mineral based oils and synthetic oils, can also be blended into the lubricating oil, as long as the wear, friction and extreme pressure properties of the overall composition are not negatively affected.

Additives which can be blended with the Fischer-Tropsch base oil to provide the lubricating oil composition, include those which are intended to improve the properties of wear, friction and extreme pressure properties of the finished lubricant. Such additives are commercially available, are known, and are available in commercially available packages. The additives for the present lubricating oil composition include a friction modifier, which is based on one or more synthetic esters, and an extreme pressure agent. The extreme pressure agent is a sulfurized extreme pressure agent, but other extreme pressure agents can be used. In another embodiment, the present lubricating oil composition designed for use in rotary pneumatic and reciprocating tools include an emulsifier and a copper corrosion inhibitor.

Other typical additives include, for example, anti-wear additives, EP agents, detergents, dispersants, antioxidants, pour point depressants, viscosity index improvers, viscosity modifiers, demulsifiers, antifoaming agents, rust inhibitors, seal swell agents, wetting agents, lubricity improvers, metal deactivators, gelling agents, tackiness agents, bactericides, fluid-loss additives, colorants, and the like.

In one embodiment, the total amount of additives in the lubricating oil composition will be approximately 0.1 to about 30 weight percent of the lubricating oil composition. However, since the Fischer-Tropsch base oils can have excellent properties including excellent oxidation stability, low wear, high viscosity index, low volatility, good low temperature properties, good additive solubility, and good elastomer compatibility, a lower amount of additives may be required for the lubricating oil composition than is typically required with base oils made by other processes. The use of additives in formulating finished lubricants is well documented in the literature and well known to those of skill in the art. In one embodiment, the Fischer-Tropsch oil will comprise at least 70 wt % of the lubricating oil, and in another embodiment, at least 90 wt % of the lubricating oil composition. In yet another embodiment, the Fischer-Tropsch base oil comprises at least 95 wt % of the composition.

In one embodiment, the Fischer-Tropsch base oils may be obtained by using a process comprising the steps of: a) performing a Fischer-Tropsch synthesis on syngas to provide a product stream; b) isolating from said product stream a substantially paraffinic wax feed having less than about 30 ppm total combined nitrogen and sulfur, and less than about 1 wt % oxygen; c) dewaxing said substantially paraffinic wax feed by hydroisomerization dewaxing using a shape selective intermediate pore size molecular sieve with a noble metal hydrogenation component wherein the hydroisomerization temperature is between about 600° F. (315° C.) and about 750° F. (399° C.), whereby an isomerized oil is produced; and d) hydrofinishing said isomerized oil.

Alternatively, step d) of the above process may be changed to: d) hydro finishing said isomerized Fischer-Tropsch oil, whereby a base oil is produced having: a weight percent of all molecules with at least one aromatic function less than 0.30, a weight percent of all molecules with at least one cycloparaffin function greater than the kinematic viscosity at 100° C. in mm²/sec. multiplied by three, and a ratio of weight percent of molecules containing monocycloparaffins to weight percent of molecules containing multicycloparaffins greater than 15.

Kinematic viscosity is a measurement of the resistance to flow of a fluid under gravity. Many lubricating base oils, finished lubricants made from them, and the correct operation of equipment depends upon the appropriate viscosity of the fluid being used. Kinematic viscosity is determined by ASTM D 445-10. The results are reported in mm²/sec. In one embodiment, the kinematic viscosities of the Fischer-Tropsch base oils used in the present lubricating oil composition are between about 2 mm²/sec. and about 20 mm²/sec., or they can be between about 2 mm²/sec. and about 12 mm²/sec.

Pour point is a measurement of the temperature at which the sample will begin to flow under carefully controlled conditions. Pour point may be determined as described in ASTM D 5950-02 (Reapproved 2007). The results are reported in degrees Celsius. Cloud point is a measurement complementary to the pour point, and is expressed as a temperature at which a sample of the lubricant base oil begins to develop a haze under carefully specified conditions. Cloud point may be determined by, for example, ASTM D 5773-10. Fischer-Tropsch base oils having pour-cloud point spreads below about 35° C. are desirable. The pour-cloud point spreads of the present Fischer-Tropsch base oils are generally less than about 35° C., preferably less than about 25° C., more preferably less than about 10° C. The cloud points are generally in the range of +30 to −30° C.

As noted previously, the Fischer-Tropsch base oils may be blended with other base oils to improve or modify their properties (e.g., viscosity index, oxidation stability, pour point, sulfur content, traction coefficient, or Noack volatility). Examples of base oils that may be blended with the Fischer-Tropsch base oils are conventional Group I base oils, conventional Group II base oils, conventional Group III base oils, other Fischer-Tropsch base oils, isomerized petroleum wax, polyalphaolefins, polyinternalolefins, oligomerized olefins from Fischer-Tropsch derived feed, diesters, polyol esters, phosphate esters, alkylated aromatics, alkylated cycloparaffins, and mixtures thereof. The amount blended, however, is generally a minor amount so that the wear, friction and extreme pressure properties are not adversely affected.

During Fischer-Tropsch synthesis, liquid and gaseous hydrocarbons are formed by contacting a synthesis gas (syngas) comprising a mixture of hydrogen and carbon monoxide with a Fischer-Tropsch catalyst under suitable temperature and pressure reactive conditions. The Fischer-Tropsch reaction is typically conducted at temperatures of from about 300° to about 700° F. (about 150° to about 370° C.) preferably from about 400° to about 550° F. (about 205° to about 230° C.); pressures of from about 10 to about 600 psia, (0.7 to 41 bars) preferably 30 to 300 psia, (2 to 21 bars) and catalyst space velocities of from about 100 to about 10,000 cc/g/hr., preferably 300 to 3,000 cc/g/hr.

The products from the Fischer-Tropsch synthesis may range from C₁ to C₂₀₀ plus hydrocarbons, with a majority in the C₅ to C₁₀₀ plus range. Fischer-Tropsch synthesis may be viewed as a polymerization reaction. Applying polymerization kinetics, a simple one parameter equation can describe the entire product distribution, referred to as the Anderson-Shultz-Flory (ASF) distribution:

Wₙ=(1−α)²×n×αⁿ⁻¹

Where Wₙ is the weight fraction of product with carbon number n, and α is the ASF chain growth probability. The higher the value of α., the longer the average chain length.

The Fischer-Tropsch reaction can be conducted in a variety of reactor types, such as, for example, fixed bed reactors containing one or more catalyst beds, slurry reactors, fluidized bed reactors, or a combination of different types of reactors. Such reaction processes and reactors are well known and documented in the literature. The slurry Fischer-Tropsch process, which is preferred in the practice of the invention, utilizes superior heat (and mass) transfer characteristics for the strongly exothermic synthesis reaction and is able to produce relatively high molecular weight, paraffinic hydrocarbons when using a cobalt catalyst. In the slurry process, a syngas comprising a mixture of hydrogen and carbon monoxide is bubbled up as a third phase through a slurry which comprises a particulate Fischer-Tropsch type hydrocarbon synthesis catalyst dispersed and suspended in a slurry liquid comprising hydrocarbon products of the synthesis reaction which are liquid under the reaction conditions. The mole ratio of the hydrogen to the carbon monoxide may broadly range from about 0.5 to about 4, but is more typically within the range of from about 0.7 to about 2.75 and preferably from about 0.7 to about 2.5. A particularly preferred Fischer-Tropsch process is taught in EP0609079, also completely incorporated herein by reference for all purposes.

Suitable Fischer-Tropsch catalysts comprise one or more Group VIII catalytic metals such as Fe, Ni, Co, Ru and Re, with cobalt being preferred. Additionally, a suitable catalyst may contain a promoter. Thus, a preferred Fischer-Tropsch catalyst comprises effective amounts of cobalt and one or more of Re, Ru, Pt, Fe, Ni, Th, Zr, Hf, U, Mg and La on a suitable inorganic support material, preferably one which comprises one or more refractory metal oxides. In general, the amount of cobalt present in the catalyst is between about 1 and about 50 weight percent of the total catalyst composition. The catalysts can also contain basic oxide promoters such as ThO₂, La₂O₃, MgO, and TiO₂, promoters such as ZrO₂, noble metals (Pt, Pd, Ru, Rh, Os, Ir), coinage metals (Cu, Ag, Au), and other transition metals such as Fe, Mn, Ni, and Re. Suitable support materials include alumina, silica, magnesia and titania, or mixtures thereof. Preferred supports for cobalt containing catalysts comprise titania. Useful catalysts and their preparation are known and illustrated in U.S. Pat. No. 4,568,663, which is intended to be illustrative but non-limiting relative to catalyst selection.

In one embodiment, the substantially paraffinic wax feed is dewaxed by hydroisomerization dewaxing at conditions sufficient to produce a Fischer-Tropsch base oil with a desired composition of cycloparaffins and a moderate pour point. For example, the conditions for hydroisomerization dewaxing can be controlled such that the conversion of the compounds boiling above about 700° F. in the wax feed to compounds boiling below about 700° F. is maintained between about 10 wt % and 50 wt %, preferably between 15 wt % and 45 wt %. Hydroisomerization dewaxing is intended to improve the cold flow properties of a lubricating base oil by the selective addition of branching into the molecular structure. Hydroisomerization dewaxing ideally will achieve high conversion levels of waxy feed to non-waxy iso-paraffins while at the same time minimizing the conversion by cracking.

In one embodiment, hydroisomerization is conducted using a shape selective intermediate pore size molecular sieve. Hydroisomerization catalysts that can be used can comprise a shape selective intermediate pore size molecular sieve and a catalytically active metal hydrogenation component on a refractory oxide support. The phrase “intermediate pore size,” as used herein means a crystallographic free diameter in the range of from about 3.9 to about 7.1 Angstrom when the porous inorganic oxide is in the calcined form. The shape selective intermediate pore size molecular sieves can be 1-D 10-, 11- or 12-ring molecular sieves. In one embodiment, the molecular sieves are of the 1-D 10-ring variety, where 10-(or 11- or 12-) ring molecular sieves have 10 (or 11 or 12) tetrahedrally-coordinated atoms (T-atoms) joined by oxygens. In the 1-D molecular sieve, the 10-ring (or larger) pores are parallel with each other, and do not interconnect. Note, however, that 1-D 10-ring molecular sieves which meet the broader definition of the intermediate pore size molecular sieve but include intersecting pores having 8-membered rings may also be encompassed within the definition of the molecular sieve of the present invention. The classification of intrazeolite channels as 1-D, 2-D and 3-D is set forth by R. M. Barrer in Zeolites, Science and Technology, edited by F. R. Rodrigues, L. D. Rollman and C. Naccache, NATO ASI Series, 1984 which classification is incorporated in its entirety by reference (see particularly page 75).

In one embodiment, the shape selective intermediate pore size molecular sieves used for hydroisomerization dewaxing are based upon aluminum phosphates, such as SAPO-11, SAPO-31, and SAPO-41. In another embodiment, the shape selective intermediate pore size molecular sieves used for hydroisomerization dewaxing are selected from SAPO-11 and SAPO-31. In another embodiment, SM-3 is the shape selective intermediate pore sized molecular sieve used for hydroisomerization dewaxing. SM-3 has a crystalline structure falling within that of the SAPO-11 molecular sieves. The preparation of SM-3 and its unique characteristics are described in U.S. Pat. Nos. 4,943,424 and 5,158,665. Other shape selective intermediate pore size molecular sieves used for hydroisomerization dewaxing are zeolites, such as ZSM-22, ZSM-23, ZSM-35, ZSM-48, ZSM-57, SSZ-32, offretite, and ferrierite. In one embodiment, the molecular sieve used for hydroisomerization dewaxing is selected from SSZ-32, SSZ-32X, ZSM-23, and mixtures thereof SSZ-32X is described in U.S. Pat. No. 7,569,507 and U.S. Pat. No. 7,468,126, herein incorporated in their entireties.

In one embodiment, the intermediate pore size molecular sieve is characterized by selected crystallographic free diameters of the channels, selected crystallite size (corresponding to selected channel length), and selected acidity. In one embodiment, the crystallographic free diameters of the channels of the molecular sieves are in the range of from about 3.9 to about 7.1 Angstrom, having a maximum crystallographic free diameter of not more than 7.1 and a minimum crystallographic free diameter of not less than 3.9 Angstrom. In one embodiment, the maximum crystallographic free diameter is not more than 7.1 and the minimum crystallographic free diameter is not less than 4.0 Angstrom. In another embodiment, the maximum crystallographic free diameter is not more than 6.5 and the minimum crystallographic free diameter is not less than 4.0 Angstrom. The crystallographic free diameters of the channels of molecular sieves are published in the “Atlas of Zeolite Framework Types”, Fifth Revised Edition, 2001, by Ch. Baerlocher, W. M. Meier, and D. H. Olson, Elsevier, pp 10 15, which is incorporated herein by reference.

If the crystallographic free diameters of the channels of a molecular sieve are unknown, the effective pore size of the molecular sieve can be measured using standard adsorption techniques and hydrocarbonaceous compounds of known minimum kinetic diameters. See Breck, Zeolite Molecular Sieves, 1974 (especially Chapter 8); Anderson et al. J. Catalysis 58, 114 (1979); and U.S. Pat. No. 4,440,871, the pertinent portions of which are incorporated herein by reference. In performing adsorption measurements to determine pore size, standard techniques are used. It is convenient to consider a particular molecule as excluded if does not reach at least 95% of its equilibrium adsorption value on the molecular sieve in less than about 10 minutes (p/po=0.5; 25° C.). Intermediate pore size molecular sieves will typically admit molecules having kinetic diameters of 5.3 to 6.5 Angstrom with little hindrance.

In one embodiment, the hydroisomerization dewaxing catalyst has a MTT framework type and the catalyst contains at least one metal selected from the group consisting of Ca, Cr, Mg, La, Na, Pr, Sr, K, and ND, and at least one Group VIII metal. These catalysts are described in US Patent Publication No. US20080083657.

In one embodiment, the hydroisomerization dewaxing catalysts have sufficient acidity so that 0.5 grams thereof when positioned in a tube reactor converts at least 50% of hexadecane at 370° C., pressure of 1200 psig, a hydrogen flow of 160 ml/min, and a feed rate of 1 ml/hr. In one embodiment, the catalyst also exhibits isomerization selectivity of 40 percent or greater (isomerization selectivity is determined as follows: 100×(weight % branched C₁₆ in product)/(weight % branched C₁₆ in product+weight % C₁₃−in product) when used under conditions leading to 96% conversion of normal hexadecane (n-C₁₆) to other species.

Hydroisomerization dewaxing catalysts can comprise a catalytically active hydrogenation noble metal. The presence of a catalytically active hydrogenation metal can lead to product improvement, especially to improvements in viscosity index and oxidation stability. The noble metals platinum and palladium can be used, either alone or in combination. In one embodiment, if platinum and/or palladium is used, the total amount of active hydrogenation metal is in the range of 0.1 to 5 weight percent of the total catalyst, or from 0.1 to 2 weight percent, and in some embodiments will not exceed 10 weight percent.

In one embodiment, the refractory oxide support can be selected from those oxide supports which are conventionally used for catalysts, including silica, alumina, silica-alumina, magnesia, titania, and combinations thereof.

In one embodiment, the conditions for hydroisomerization dewaxing depend on the feed used, the catalyst used, whether or not the catalyst is sulfided, the desired yield, and the desired properties of the lubricant base oil. In one embodiment, conditions under which the hydroisomerization dewaxing can be carried out include temperatures from about 600° F. to about 750° F. (315° C. to about 399° C.), such as from about 600° F. to about 700° F. (315° C. to about 371° C.); and pressures from about 15 to 3000 psig, such as from 100 to 2500 psig. The hydroisomerization dewaxing pressures in this context refer to the hydrogen partial pressure within the hydroisomerization reactor, although the hydrogen partial pressure is substantially the same (or nearly the same) as the total pressure. The liquid hourly space velocity during contacting can be from about 0.1 to 20 hr⁻¹, for example, from about 0.1 to about 5 hr⁻¹. In one embodiment, the hydrogen to hydrocarbon ratio falls within a range from about 1.0 to about 50 moles H₂ per mole hydrocarbon, such as from about 10 to about 20 moles H₂ per mole hydrocarbon. Suitable conditions for performing hydroisomerization are described in U.S. Pat. Nos. 5,282,958 and 5,135,638, the contents of which are incorporated by reference in their entirety.

In one embodiment, hydrogen is present in the reaction zone during the hydroisomerization dewaxing process. For example, the hydrogen to feed ratio can be from about 0.5 to 30 MSCF/bbl (thousand standard cubic feet per barrel), or from about 1 to about 10 MSCF/bbl. In one embodiment, hydrogen will be separated from the product and recycled to the reaction zone.

Hydrotreating refers to a catalytic process, usually carried out in the presence of free hydrogen, in which the primary purpose is the removal of various metal contaminants, such as arsenic, aluminum, and cobalt; heteroatoms, such as sulfur and nitrogen; oxygenates; or aromatics from the feed stock. In one embodiment, in hydrotreating operations cracking of the hydrocarbon molecules, i.e., breaking the larger hydrocarbon molecules into smaller hydrocarbon molecules, is minimized, and the unsaturated hydrocarbons are either fully or partially hydrogenated. In one embodiment, waxy feed that is used to make the Fischer-Tropsch base oil is hydrotreated prior to hydroisomerization dewaxing.

Catalysts used in carrying out hydrotreating operations are well known in the art. See for example U.S. Pat. Nos. 4,347,121 and 4,810,357, the contents of which are hereby incorporated by reference in their entirety, for general descriptions of hydrotreating, hydrocracking, and of typical catalysts used in each of the processes. Suitable catalysts include noble metals from Group VIIIA (according to the 1975 rules of the International Union of Pure and Applied Chemistry), such as platinum or palladium on an alumina or siliceous matrix, and Group VIII and Group VIB, such as nickel-molybdenum or nickel-tin on an alumina or siliceous matrix. U.S. Pat. No. 3,852,207 describes a suitable noble metal catalyst and mild conditions. Other suitable catalysts are described, for example, in U.S. Pat. Nos. 4,157,294 and 3,904,513. In one embodiment, the non-noble hydrogenation metals, such as nickel-molybdenum, can be present in the final catalyst composition as oxides, and can also be employed in their reduced or sulfided forms when such sulfide compounds are readily formed from the particular metal involved. In one embodiment, the non-noble metal catalyst compositions contain in excess of about 5 weight percent, such as from about 5 to about 40 weight percent molybdenum and/or tungsten, and can contain at least about 0.5, such as from about 1 to about 15 weight percent of nickel and/or cobalt determined as the corresponding oxides. In one embodiment, catalysts containing noble metals, such as platinum, can contain in excess of 0.01 percent metal, e.g., between about 0.1 and 1.0 percent metal. In other embodiments, combinations of noble metals can also be used, such as mixtures of platinum and palladium.

In one embodiment, hydrotreating conditions vary over a wide range. In one embodiment, the overall LHSV is about 0.25 to 2.0, such as about 0.5 to 1.5. In one embodiment, the hydrogen partial pressure is greater than 200 psia, and can be from about 500 psia to about 2000 psia. In one embodiment, hydrogen recirculation rates can be greater than 50 SCF/Bbl, such as between 1000 and 5000 SCF/Bbl. In one embodiment, temperatures in the hydrotreating reactor can range from about 300° F. to about 750 degrees F. (about 150° C. to about 400° C.), or from 450° F. to 725° F. (230° C. to 385° C.).

In one embodiment, hydrotreating is used as a step following hydroisomerization dewaxing in the lubricant base oil manufacturing process to make the Fischer-Tropsch base oil. This step, herein called hydrofinishing, is intended to improve the oxidation stability, UV stability, and appearance of the product by removing traces of aromatics, olefins, color bodies, and solvents. As used in this disclosure, the term UV stability refers to the stability of the lubricating base oil or the finished lubricant when exposed to UV light and oxygen. Instability is indicated when a visible precipitate forms, usually seen as floc or cloudiness, or a darker color develops upon exposure to ultraviolet light and air. A general description of hydrofinishing may be found in U.S. Pat. Nos. 3,852,207 and 4,673,487. Clay treating to remove these impurities is an alternative final process step.

Optionally, the process of preparing a Fischer-Tropsch base oil may include fractionating of the substantially paraffinic wax feed prior to hydroisomerization dewaxing, or fractionating of the lubricating base oil. The fractionation of the substantially paraffinic wax feed or lubricating base oil into distillate fractions is generally accomplished by either atmospheric or vacuum distillation, or by a combination of atmospheric and vacuum distillation. Atmospheric distillation is typically used to separate the lighter distillate fractions, such as naphtha and middle distillates, from a bottoms fraction having an initial boiling point above about 600° F. to about 750° F. (about 315° C. to about 399° C.). At higher temperatures thermal cracking of the hydrocarbons may take place leading to fouling of the equipment and to lower yields of the heavier cuts. Vacuum distillation is typically used to separate the higher boiling material, such as the lubricating base oil fractions, into different boiling range cuts. Fractionating the lubricating base oil into different boiling range cuts enables the lubricating base oil manufacturing plant to produce more than one grade, or viscosity, of lubricating base oil.

Solvent dewaxing may be optionally used to remove small amounts of remaining waxy molecules from the lubricating base oil after hydroisomerization dewaxing. Solvent dewaxing is done by dissolving the lubricating base oil in a solvent, such as methyl ethyl ketone, methyl iso-butyl ketone, or toluene, or precipitating the wax molecules as discussed in Chemical Technology of Petroleum, 3rd Edition, William Gruse and Donald Stevens, McGraw-Hill Book Company, Inc., New York, 1960, pages 566 to 570. See also U.S. Pat. Nos. 4,477,333, 3,773,650 and 3,775,288.

The Fischer-Tropsch base oils used in preparing the present lubricating oil compositions can have low levels of unsaturation. In one embodiment, the level of unsaturation is less that 20 weight percent, as determined by elution column chromatography, ASTM D 2549-02 (Reapproved 2007). In another embodiment, the level of unsaturations is from 5 to 50 wt %, or from 10 to 40 wt %.

Lubricating oils can come into direct contact with seals, gaskets, and other equipment components during use. Original equipment manufacturers and standards setting organizations set elastomer compatibility specifications for different types of finished lubricants. Examples of elastomer compatibility tests are CEC L-39-T-96, and ASTM D 4289-03. An ASTM standard entitled “Standard Test Method and Suggested Limits of Determining the Compatibility of Elastomer Seals for Industrial Hydraulic Fluid Applications” is currently in development. Elastomer compatibility test procedures involve suspending a rubber specimen of known volume in the lubricating base oil or finished lubricant under fixed conditions of temperature and test duration. This is followed at the end of the test by a second measurement of the volume to determine the percentage swell that has occurred. Additional measurements may be made of the changes in elongation at break and tensile strength. Depending on the rubber type and application, the test temperature may vary significantly. The present lubricating oil compositions are compatible with a broad number of elastomers, including but not limited to the following: neoprene, nitrile (acrylonitrile butadiene), hydrogenated nitrile, polyacrylate, ethylene-acrylic, silicone, chlor-sulfonated polyethylene, ethylene-propylene copolymers, epichlorhydrin, fluorocarbon, perfluoroether, and PTFE.

The process for manufacturing the lubricating oil composition includes the step of blending the Fischer-Tropsch base oil with at least the friction modifier based on synthetic esters and a sulfurized extreme pressure agent. The friction modifier based on a synthetic ester provides a lower coefficient of friction to the lubricating oil blended with it. Examples of synthetic esters are diesters, phthalates, trimellitates, pyromellitates, dimerates, polyols, polyoleates, and complex polyols. In one embodiment the synthetic ester is made from a multifunctional alcohols, such as neopentylglycol (NPG), trimethylolpropane (TMP, pentaerythritol (PE), or mixtures thereof. In one embodiment, the synthetic ester is a diester or triester made by processes disclosed in US20080194444, U.S. Pat. No. 7,544,645, US20090088351, US20100311625, US20090198075, or U.S. patent application Ser. No. 12/962,193, filed Dec. 7, 2010.

In one embodiment the friction modifier based on a synthetic ester comprises long, slim molecules with a straight hydrocarbon chain consisting of at least 10 carbon atoms and a polar group at one end. In one embodiment, the synthetic ester is a partial ester, for example glycerol mono oleate. In another embodiment, the synthetic ester is a fatty acid sorbitan ester. In another embodiment, the synthetic ester is a borated or unborated fatty acid ester of glycerol. In one embodiment, the synthetic ester is an ester of pentaethrythritol and C6-C20 fatty acids. In another embodiment, the synthetic ester is a ester from polyol, and C12-C28 branched or cyclic fatty acids.

A sulfurized extreme pressure agent is a sulfur carrier that contains sulfur in its oxidation state 0 or −1, where the sulfur atom is bound either to a hydrocarbon or to another sulfur atoms, and does not contain other hetero atoms except oxygen. The sulfurized extreme pressure can be made by adding sulfur to different kinds of unsaturated, double-bond-containing compounds such as olefins, natural esters, acrylates, and others. Some examples of sulfurized extreme pressure agents include: sulfurized isobutene, active-type sulfurized olefins, inactive sulfurized alpha olefins, inactive sulfurized alpha olefins, sulfurized synthetic esters, sulfurized fatty oil, and sulfurized fatty oil and olefin mixtures.

An emulsifier and copper corrosion inhibitor are also additives that can be used in the lubricating oil. Other additives which can be blended with the Fischer-Tropsch base oil to form the lubricating oil composition include those which are intended to improve other certain properties of the finished lubricant. Typical additives include, for example, anti-wear additives, EP agents, detergents, dispersants, antioxidants, pour point depressants, Viscosity Index improvers, viscosity modifiers, antifoaming agents, rust inhibitors, seal swell agents, wetting agents, lubricity improvers, metal deactivators, gelling agents, tackiness agents, bactericides, fluid-loss additives, colorants, and the like. In one embodiment, the total amount of additive in the lubricating oil composition is within the range of 0.1 to 30 weight percent. In one embodiment, the amount of Fischer-Tropsch base oil in the lubricating oil composition is between 70 and 99.9 weight percent, such as between 90 and 99 weight percent. Lubricant additive suppliers will provide information on effective amounts of their individual additives or additive packages to be blended with lubricating base oils to make finished lubricants.

Another desirable additive to be used in the lubricating oil composition is a tackiness agent. A tackiness agent is a solution of polymers in oil. The polymers can be of a molecular weight from 400,000 to 4,000,000. Examples of polymers used in tackiness agents are polyisobutylene, olefin copolymers, natural rubber, polyisobutylene/acrylic co-polymers, and ethylene/propylene co-polymers. A demonstration of tackiness is the time-honored “finger test” where the tacky solution will draw a filament across the airspace as the fingers are pulled apart. The tacking quality would also make the present lubricating oil composition suitable for once-through application, e.g., lubrication of chain drives.

Overall, the extreme pressure chemistry of the present lubricating oil composition makes it an excellent industrial extreme-pressure gear lubricant. The lubricating oil composition, therefore finds an important application in a system of enclosed industrial gears. As well, the lubricating oil composition finds application as an excellent stamping and drawing fluid for the metal working industry.

The lubricating oil has excellent load-carrying properties. In one embodiment, the lubricating oil exhibits medium or high levels of extreme-pressure properties. In one embodiment, the lubricating oil has a true load value at which failure occurs in the Falex Pin and Vee Block Method Test (ASTM D3233-93[Reapproved 2009]^{£1}, Test Method A, of at least 3500 lb, at least 3600 lb, at least 3700 lb, or at least 3800 lb.

In one embodiment, the lubricating oil has a passing result in the 4-hour Tort B rust test, according to ASTM D665-06 Procedure B, using synthetic seawater. In another embodiment, the lubricating oil has both a passing result in the 4-hour Tort B rust test and a passing result in the 24-hour Tort B rust test. ASTM D665-06 is the Standard Test Method for Rust-Preventing Characteristics of Inhibited Mineral Oil in the Presence of Water.

In one embodiment, the lubricating oil has a VI greater than 120, greater than 130, greater than 140, or greater than 150. VI is determined using ASTM D 2270-10, the Standard Practice for Calculating Viscosity Index from Kinematic Viscosity at 40 and 100° C.

In one embodiment, the lubricating oil has a color less than 1.0 or less than 0.5, according to ASTM D 1500-07, the Standard Test Method for ASTM Color of Petroleum Products (ASTM Color Scale).

In one embodiment the lubricating oil has an of ISO viscosity grade of ISO 32 or higher. In another embodiment, the lubricating oil has an ISO viscosity grade from ISO 32 to ISO 680. ISO viscosity grades are determined according to the following table:

| | | |
|---|---|---|
| | | Limits of Kinematic |
| ISO | Average Kinematic | Viscosity at 40° C. |
| Viscosity | Viscosity at 40° C. | mm²/s |

| Grade | mm²/s | min. | max. |
|---|---|---|---|
| ISO VG 32 | 32 | 28.8 | 35.2 |
| ISO VG 46 | 46 | 41.4 | 50.6 |
| ISO VG 68 | 68 | 61.2 | 74.8 |
| ISO VG 100 | 100 | 90 | 110 |
| ISO VG 150 | 150 | 135 | 165 |
| ISO VG 220 | 220 | 198 | 242 |
| ISO VG 320 | 320 | 288 | 352 |
| ISO VG 460 | 460 | 414 | 506 |
| ISO VG 680 | 612 | 612 | 748 |
| ISO VG 1000 | 1000 | 900 | 1100 |
| ISO VG 1500 | 1500 | 1350 | 1650 |

### Example

A series of ISO 46 grade lubricating oils were prepared using a commercially available additive package containing a friction modifier based on synthetic esters and sulfurized extreme pressure agents. Comparative lubricants (non-Fischer-Tropsch) from API Groups I, II, III and IV were used and compared to the Fischer-Tropsch-based lubricating oil. The additive package was solubilized in the Fischer-Tropsch based lubricating oil at least as well as, if not better than, the comparative lubricants.

The specifications for Lubricant Base Oils defined in the API Interchange Guidelines (API Publication 1509) using sulfur content, saturates content, and viscosity index, are shown below in Table I:

TABLE I

| Group | Sulfur, ppm | | Saturates, % | VI |
|---|---|---|---|---|
| I | >300 | and/or | <90 | 80-120 |
| II | ≦300 | and | ≧90 | 80-120 |
| III | ≦300 | and | ≧90 | >120 |

| | |
|---|---|
| IV | All Polyalphaolefins |
| V | All Stocks Not Included in Groups I-IV |

Facilities that make Group I lubricant base oils typically use solvents to extract the lower viscosity index (VI) components and increase the VI of the crude to the specifications desired. These solvents are typically phenol or furfural. Solvent extraction gives a product with less than 90% saturates and more than 300 ppm sulfur. The majority of the lubricant production in the world is in the Group I category.

Facilities that make Group II lubricant base oils typically employ hydroprocessing such as hydrocracking or severe hydrotreating to increase the VI of the crude oil to the specification value. The use of hydroprocessing typically increases the saturate content above 90 and reduces the sulfur below 300 ppm. Approximately 10% of the lubricant base oil production in the world is in the Group II category, and about 30% of U.S. production is Group II.

Facilities that make Group III lubricant base oils typically employ wax isomerization technology to make very high VI products. Since the starting feed is waxy vacuum gas oil (VGO) or wax which contains all saturates and little sulfur, the Group III products have saturate contents above 90 and sulfur contents below 300 ppm. Fischer-Tropsch wax is an ideal feed for a wax isomerization process to make Group III lubricant base oils. Only a small fraction of the world's lubricant supply is in the Group III category.

Group IV lubricant base oils are derived by oligomerization of normal alpha olefins and are called poly alpha olefin (PAO) lubricant base oils.

Below are results showing a Fischer-Tropsch based lubricating oil (E) to have superior wear, friction and extreme pressure properties—as measured by the Falex Pin and Vee Block Machine—compared to Group 1, Group II, Group III (mineral oil-derived) and PAO-based formulations. The Fischer-Tropsch based lubricating oil obtained a 3700 lb result on the Falex EP test. This was unexpected, and it demonstrated that Fischer-Tropsch base oils can be used to further reduce and optimize the friction and extreme pressure properties of a lubricant.

| | | ISO Viscosity Grade | | | | |
|---|---|---|---|---|---|---|
| | | ISO 46 | ISO 46 | ISO 46 | ISO 46 | ISO 46 |
| | | Identification | | | | |
| | | A | B | C | D | E |
| | | Base Oils - Group Type | | | | |
| | Method | | | III - Mineral | | Fischer- |
| Test | (ASTM) | I | II | Oil | PAO (IV) | Tropsch |
| Kinematic Viscosity | D445-10 | 44.65 | 44.04 | 44.12 | 42.83 | 44.24 |
| @40° C. | | | | | | |
| Kinematic Viscosity | D445-10 | 6.942 | 7.006 | 7.667 | 7.561 | 8.106 |
| @100° C. | | | | | | |
| VI | D2270-10 | 112 | 117 | 143 | 145 | 159 |
| Color | D1500-07 | L1.0 | L0.5 | L0.5 | L0.5 | L0.5 |
| Appearance | | Bright, | Bright, | Barely | Contains | Barely |
| | | no cloud, | no cloud, | detectable | sediment | detectable |
| | | floc or | floc or | cloud | | cloud |
| | | sediment | sediment | | | |
| Copper Strip, 3 hrs at | D130-10 | 3a | 1b | 1b | 3a | 1b |
| 100° C. | | | | | | |
| Rust 4 hr/24 hr | D665-06, | P/P | P/P | P/P | P/P | P/P |
| | Procedure B | | | | | |
| Falex True Load, lbf | D3233 - 93 | 3100 | 2500 | 2800 | 3500 | 3700 |
| | (Reapproved | | | | | |
| | 2009) ^{ε1} Test | | | | | |
| | Method A | | | | | |

Various modifications and alterations of this invention will become apparent to those skilled in the art without departing from the scope and spirit of the invention. Other objects and advantages will become apparent to those skilled in the art from a review of the preceding description.

That which is claimed is:

1. A rotary pneumatic or reciprocating tool comprising a lubricating oil, wherein the lubricating oil comprises a Fischer-Tropsch base oil, a friction modifier based on a synthetic ester, and a sulfurized extreme pressure agent.

2. The tool of claim 1, wherein the tool is a rock drill.

3. The tool of claim 1, wherein the tool is a jack hammer.

4. The tool of claim 1, wherein the lubricating oil further comprises an emulsifier.

5. The tool of claim 1, wherein the lubricating oil further comprises a copper corrosion inhibitor.

6. The tool of claim 5, wherein the lubricating oil further comprises a copper corrosion inhibitor.

7. The tool of claim 1, wherein the Fischer-Tropsch base oil has a Viscosity Index (VI) of at least 120.

8. The tool of claim 1, wherein the Fischer-Tropsch base oil has a Viscosity Index (VI) of at least 150.

9. The tool of claim 1, wherein the lubricating oil further comprises a second Fischer-Tropsch base oil.

10. The tool of claim 1, wherein the Fischer-Tropsch base oil has a viscosity of at least 120 and the lubricating oil further comprises an emulsifier and a copper corrosion inhibitor.

11. The tool of claim 1, wherein the lubricating oil comprises at least 70 wt % Fischer-Tropsch base oil.

12. The tool of claim 1, wherein the lubricating oil comprises at least 90 wt % Fischer-Tropsch base oil.

13. The tool of claim 1, wherein the lubricating oil comprises at least 95 wt % Fischer-Tropsch base oil.

14. The tool of claim 1, wherein the lubricating oil has a true load value at which failure occurs in the Falex Pin and Vee Block Method Test of at least 3600 lb.

15. The tool of claim 1, wherein the lubricating oil has a true load value at which failure occurs in the Falex Pin and Vee Block Method Test of at least 3700 lb.

16. The tool of claim 1, wherein the lubricating oil has a passing result in the 4-hour Tort B rust test.

17. The tool of claim 1, wherein the lubricating oil has a passing result in the 24-hour Tort B rust test.

18. The tool of claim 1, wherein the lubricating oil has a VI greater than 120.

19. The tool of claim 1, wherein the lubricating oil has a VI greater than 150.

20. The tool of claim 1, wherein the lubricating oil has a color less than 0.5.

21. A system of enclosed industrial gears, comprising a lubricant, wherein the lubricant comprises a Fischer-Tropsch base oil, a friction modifier based on a synthetic ester, and a sulfurized extreme pressure agent.

22. The system of claim 21, wherein the lubricant comprises at least 90 wt % Fischer-Tropsch base oil.
